(19) United States
(12) Patent Application Publication
(10) Pub. No.: US 2005/0240421 A1
(43) Pub. Date: Oct. 27, 2005

(54) Web-based process leveraging database

(75) Inventors: Jeff Keller, Cincinnati, OH (US); Howard Farr, Cincinnati, OH (US); Jeffri E. Love, Cincinnati, OH (US)

Correspondence Address: Barbara Joan Haushalter;Law Office, 228 Bent Pines Court, Bellefontaine, OH, 43311, US

(73) Assignee: General Electric Company

(21) Appl. No.: 10/830,651

(22) Filed: Apr. 23, 2004

(51) Int. Cl. G06F 17/60

(52) U.S. Cl. 705/1

(57) ABSTRACT

The present invention provides a structured web-based process leveraging database for identifying high-leverage potential manufacturing and inspection processes. The internet-based leveraging application of the subject invention can be populated with worthwhile technology improvements, preventing duplication of efforts, and fostering quicker implementation of the worthwhile technology improvements at other sites. The web-based leveraging application also allows the processes to be categorized, detailed information about the process to be provided, and tracking of the progress of the leveraging across world-wide operations.

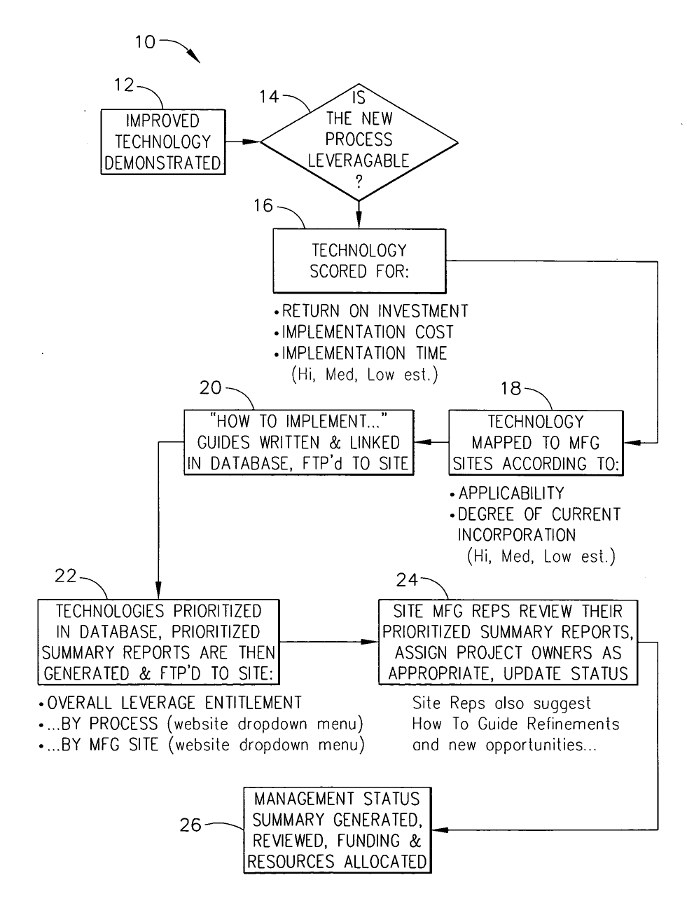

### BACKGROUND OF THE INVENTION

The present invention relates to web-based processes in all types of business environments.

There are many companies today with a world-wide presence, and a diverse range of operations. When entities operate multiple facilities world-wide, propagating or leveraging process improvements across such diverse operations can be extremely challenging. The dissemination of information to all relevant facilities is further complicated by the requirement to propagate information rapidly, effectively, and accurately. Misinterpretation or unawareness of process improvements may inadvertently result in the perpetuation of a process effort that is non-compliant with relevant and current requirements and may ultimately result in field related problems.

In the past, efforts have been made to promote process breakthroughs via structured meetings, email distribution, teleconferences, and informal networks of engineers in similar fields. Unfortunately the rapidity with which some process improvement projects progress, has made it difficult for these multiple and unstructured dissemination routes to be entirely effective. Hence, leveraging process improvements is currently dependent on the dissemination of such improvements across multiple and meandering routes, adding to the cost of operations without the benefit of efficiency.

It would be desirable to provide a more real-time and direct dissemination method and system for propagating or leveraging process improvements across diverse operations.

### BRIEF SUMMARY OF THE INVENTION

A method and system is proposed for effectively providing a structured leveraging of process improvements across diverse operations. This provides the dissemination of thorough manufacturing and inspection improvement projects to all relevant manufacturing, repair and operations facilities throughout the world.

Accordingly, the present invention provides a structured web-based process leveraging database for identifying high-leverage potential manufacturing and inspection processes. The internet-based leveraging application of the subject invention can be populated with worthwhile technology improvements, preventing duplication of efforts, and fostering quicker implementation of the worthwhile technology improvements at other sites. The web-based leveraging application also allows the processes to be categorized, detailed information about the process to be provided, and tracking of the progress of the leveraging across world-wide operations.

### BRIEF DESCRIPTION OF THE DRAWING

The FIGURE is a schematic block diagram illustrating the web-based process used to populate the leveraging site, in accordance with the present invention.

### DETAILED DESCRIPTION OF THE INVENTION

Referring to the FIGURE, there is a schematic block diagram 10 illustrating the process for propagating process improvements across diverse operations. It is typical for corporations to have established guidelines for manufacturing and inspection of parts and products, particularly when safety is an issue with products or parts, as in the aerospace and automotive industries. These guidelines, or design practices, are contained together for reference during the design process. Very thorough manufacturing and inspection improvement projects are also continuously developed and implemented. The resultant improvements need to be effectively propagated to all relevant manufacturing and repair facilities, in a structured and efficient manner.

By way of example, process breakthroughs establish guidelines for the aerodynamic design of gas turbine engine components. The flowchart diagram 10 of the FIGURE outlines the steps for achieving the structured means for implementing the present invention. Initially, at block 12, the improved technology enters the web-based application and is demonstrated.

At decision block 14, a determination is made as to whether the proposed improved technology is leveragable. If a given technology is not applicable to other manufacturing facilities, the concept is not added to the leverage tool website. However, if at least one other manufacturing facility has a similar manufacturing process which might be replaced by the improved process, the concept is deemed, at block 14, to be “leveragable”. Many corporations are encouraging the sharing of “best practices” among all of its facilities, and thereby multiply or “leverage” a technology investment. If one, of multiple world-wide sites, spends resources to refine or replace a costly manufacturing process, the process can be evaluated using the present invention, to determine whether it might offer similar benefits to other facilities doing similar repairs or maintenance or production. If the assessment shows that the refined or replaced process even might benefit other facilities, the concept is added to the leveraging database of the subject invention, for consideration by engineers or other decision-making authorities, at one or more of the other facilities that might possibly benefit. Hence, the resources expended at the initial location can provide the benefit to other locations without concurrent expenditure of resources. Leveraging the technology investment of one manufacturing facility to several others, improves the return on investment for the entire corporation or entity.

Continuing with the FIGURE, if it is determined at decision block 14 that the proposed improved technology is leveragable, then the process proceeds to block 16 to score the technology. For example, the technology can be scored for return on investment, implementation cost, implementation time, etc., with “hi”, “medium” and “low” ratings. After the technology is scored, the technology is then mapped, at block 18, to sites of interest, such as manufacturing sites, according to predetermined standards, such as applicability, degree of current incorporation, etc., again, on “hi”, “medium” and “low” estimates.

At this point in the process, “How To Implement . . . ” guides can be written and linked to the database, and be uploaded using any suitable File Transfer Protocol (FTP) to the site, as indicated at block 20. The file can be uploaded to an internet or intranet web server, making it accessible to authorized parties around the world. The technologies can be prioritized in the database, and summary reports can be prioritized and generated and also uploaded or otherwise transferred to the site of interest, as shown at block 22. The overall leverage entitlement can be by process or by manufacturing site, by way of example, utilizing a website dropdown menu. At block 24, the site manufacturing representatives review their prioritized summary reports, and assign project owners, as appropriate, and update the status of the technology. Site representatives can also provide input and suggestions for refining the “How To . . . ” guide, and offer new opportunities for the improved technology. Finally, at block 26, a management status summary can be generated, reviewed, funded, and have resources allocated. The propagation of manufacturing and inspection improvements positively affects product quality by reducing the vulnerability associated with misinterpretation or lack of awareness of process breakthroughs. The process also improves productivity by reducing the expenditures of time and manpower to disseminate information, and to implement improvements to minimize inefficiencies.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for disseminating information within a defined structure such as a corporate entity, the method comprising the steps of:
proposing a new technology;
determining if the proposed new technology is leveragable;
rating criteria for the proposed new technology;
applying a review to the proposed new technology, based on the rating criteria.

2. A method as claimed in claim 1 further comprising the step of providing the proposed new technology to sites related to the corporate entity to which the proposed new technology is applicable.

3. A method as claimed in claim 1 further comprising the step of instructing manufacturing representatives of the corporate entity to review the proposed new technology for possible application at sites related to the corporate entity.

4. A method as claimed in claim 2 further comprising the step of providing manufacturing process improvement implementation instructions for implementing the proposed new technology.

5. A method as claimed in claim 4 wherein the step of providing manufacturing process improvement implementation instructions further comprises the step of writing implementation guides for upload to an internet or intranet web server.

6. A method as claimed in claim 1 wherein the step of determining if the proposed new technology is leveragable further comprises the step of determining if any sites of the corporate entity might benefit from implementation of the proposed new technology.

7. A method as claimed in claim 1 wherein the step of rating criteria for the proposed new technology further comprises the step of scoring the proposed new technology based on return on investment, implementation cost, or implementation time.

8. A system for disseminating information within a defined structure such as a corporate entity, comprising:
a new technology concept;
means for determining if the new technology concept is leveragable;
criteria for rating the new technology concept;
means for applying a review to the proposed new technology, based on the rating criteria.

9. A system as claimed in claim 8 further comprising means for providing the proposed new technology to sites related to the corporate entity to which the proposed new technology is applicable.

10. A system as claimed in claim 8 further comprising a review means available to manufacturing representatives of the corporate entity to review the new technology concept for possible application at sites related to the corporate entity.

11. A system as claimed in claim 10 further comprising manufacturing process improvement implementation instructions for implementing the proposed new technology.

12. A system as claimed in claim 11 wherein the manufacturing process improvement implementation instructions further comprise written implementation guides for upload to an internet or intranet web server.

13. A system as claimed in claim 8 wherein the means for determining if the new technology concept is leveragable further comprises means for determining if any sites of the corporate entity might benefit from implementation of the proposed new technology.

14. A system as claimed in claim 8 wherein the criteria for rating the new technology concept comprises return on investment, implementation cost, or implementation time.
